(19) United States
(12) Patent Application Publication
(10) Pub. No.: US 2015/0171787 A1
(43) Pub. Date: Jun. 18, 2015

(54) OUTDOOR FRAME SYSTEM

(71) Applicant: HATICON GMBH, Pinnow (DE)

(72) Inventor: Gido Genschorek, Mescherin/OT Radekow (DE)

(73) Assignee: Sapa Holding GmbH, Offenburg (DE)

(21) Appl. No.: 14/388,863

(22) PCT Filed: Feb. 8, 2013
(86) PCT No.: PCT/DE2013/000081

§ 371 Date: Sep. 29, 2014

(30) Foreign Application Priority Data
Mar. 30, 2012 (DE) 10 2012 006 939.1
Mar. 30, 2012 (DE) 20 2012 003 492.8

(51) Int. Cl. H02S 20/30; E04C 3/32; E04C 3/07; F16B 7/04

(52) U.S. Cl. CPC H02S 20/30; F16B 7/0486; F16B 7/0446; E04C 3/32; E04C 3/07

(57) ABSTRACT

An outdoor frame system in which supports (2) with a hollow profile are connected to girders (3) by pedestal bearings (1). The connection between the support (2) and the pedestal bearing (1) is a bolt connection (4), in which a bolt (5) is guided through opposing support walls and thus passes through the pedestal bearing (1) through a foot-end eyelet (6) in the pedestal bearing (1) within the support (2). The pedestal bearing (1) protrudes beyond the upper end of the support, and at the head end has a contact surface (8) for the girder (3) and has means (7) for producing a clamping connection to attachments of the girder (3). The pedestal bearing (1) and therefore the contact surface (8) are able to tilt by an angle alpha about the axis of the bolt connection (4).

The invention relates to an outdoor frame system for mounting solar panels. In each case, a pedestal bearing connects a support of an outdoor frame to a girder, on which girder the solar panels can then be mounted, wherein the supports, pedestal bearings and girders are part of a frame system and are therefore matched to one another for mounting.

Angles or adapter plates are usually used in order to use supports with girders (DE 20 2011 050 330 U1). DE 20 2007 012 570 U1 describes a pole header element having a multiple screw connection which can be mounted.

These individual solutions are not only expensive, but are also labor-intensive in terms of their assembly.

A device for mounting solar modules is known from EP 2 147 262 B1, in which props which are rammed into the ground are used, which props are connected by means of a rail, a rocker bearing and a connecting flange to a support for the solar modules. By using a rocker bearing with a spherically curved sliding pairing an adjustment of the inclination and compensation from the perpendicular are made possible for the support surface of the connecting flange.

The increase in outdoor frames is again raising the question of how to effectively connect supports and girders. Multiple screw connections to a flange or adapter which are, additionally, difficult to access do not meet the requirements of an effective and efficient installation.

The object of the invention is to therefore propose an outdoor frame system which effectively allows girders to be mounted on supports and which is substantially based on cut-to-length extruded profiles.

This object is achieved with the features of claim 1, while advantageous embodiments are the subject matter of the dependent claims.

In the outdoor frame system according to the invention, the supports which have a hollow profile are connected to girders by means of pedestal bearings,

wherein the connection between the support and the pedestal bearing is a bolt connection, in which a bolt is guided through opposing support walls and thus passes through the pedestal bearing through a foot-end eyelet in the pedestal bearing within the support,

wherein the pedestal bearing protrudes beyond the upper end of the support, and at the head end has a contact surface for the girder, and means for producing a clamping connection to attachments of the girder, and

wherein the form of the pedestal bearing foot, the hollow profile of the supports and the arrangement of the bolt connection are matched to one another in such a manner that the pedestal bearing and therefore the contact surface are able to tilt by an angle α about the axis of the bolt connection. The angle of inclination α which can be achieved with respect to a horizontal arrangement of the contact surface should be up to 45°, preferably up to 35°.

In an advantageous embodiment two side faces of the pedestal bearing lie flat against the inner profile surfaces of the support, or are only a small distance from said profile surfaces such that by tightening the bolt connection, the side faces of the pedestal bearing can be braced with the inner profile surfaces of the support, producing a friction closure.

The attachments of the girder for producing a clamping connection to the pedestal bearing preferably consist of bent webs on the contact surface side of the girder, whereby the free web ends face each other.

The means of the pedestal bearing for producing a clamping connection to the attachments of the girder preferably consist of a stationary jaw and a movable clamping jaw, each of which can be brought into engagement with the attachments of the girder.

In an advantageous embodiment, with such a configuration of the attachments, the free end of the one web of the girder engages in a groove of the stationary jaw and engages the clamping jaw which is movably arranged at the head end on the pedestal bearing over the other web, in order to produce a clamping connection.

In a further embodiment of the connection between the pedestal bearing and the girder, a support surface of the girder is arranged for the contact surface of the pedestal bearing between the bent webs of the girder and at a distance from said webs. The support surface of the girder and the outer surfaces of the bent parts of the webs are preferably located in one plane.

With respect to the arrangement of the clamping jaw, the pedestal bearing has a guide groove for the movable clamping jaw at the head end such that the clamping jaw can be displaced from one groove wall towards the other groove wall, in a preferred embodiment. Thus, in an advantageous embodiment, the outer groove wall of the guide groove comprises a bore for accommodating a clamping screw, said clamping screw having a threaded connection with the clamping jaw, so that the clamping jaw can be displaced by turning the clamping screw.

In a preferred embodiment, the clamping jaw has a bore for the threaded connection between the clamping screw and the clamping jaw, behind which bore a clamping bolt nut is arranged in a rotationally fixed manner in an offset groove. It would of course also be possible to provide a threaded bore in the clamping jaw. However, this would involve a further technological step, namely cutting a thread into the bore. The offset groove is the result of the extrusion.

In a preferred embodiment, the clamping jaw has a U-profile in cross section, whereby on fixing the girder the one outer leg engages over a bent web of the girder, while the other leg is supported in a groove of the outer groove wall.

In addition, in an advantageous embodiment, an elastic locking plate, which is braced on clamping the girder, is arranged between the outer groove wall and the head of the clamping screw.

In the case of the proposed outdoor frame system the components
pedestal bearings
supports
girders
locking plate and/or
movable clamping jaw
   can be produced with minimal effort by cutting to length AL extruded profiles. In addition, a bore is to be inserted into each of a groove wall, the clamping jaw and, if used at all, into the locking plate, and stainless steel bolts and nuts are to be added.

In addition to the optimum production technology for the components, the outdoor frame system is also easy to install. The installation is limited to the production of two screw connections, with the position of the screws being easily accessible.

The outdoor mounting system will be explained with reference to the figures, wherein

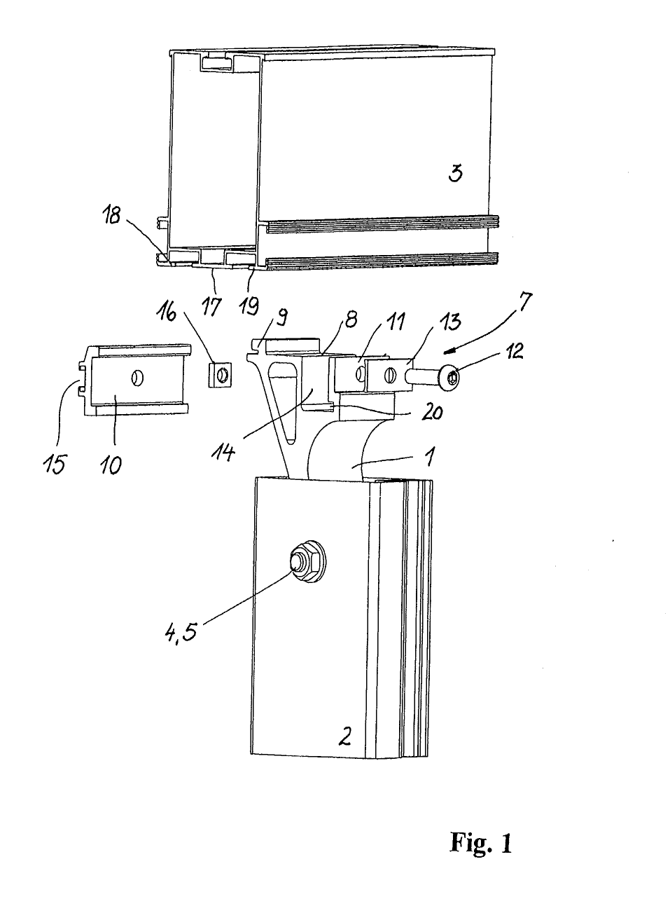

FIG. 1 shows an overview of the parts used,

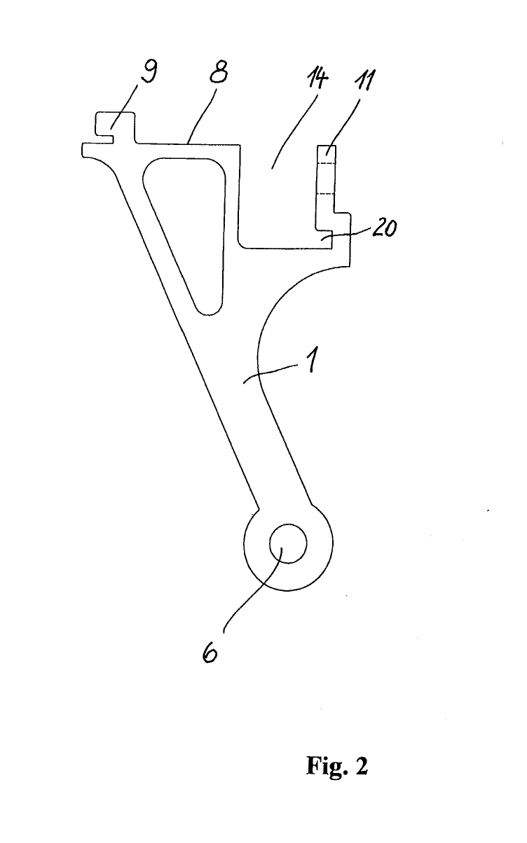

FIG. 2 shows a pedestal bearing and

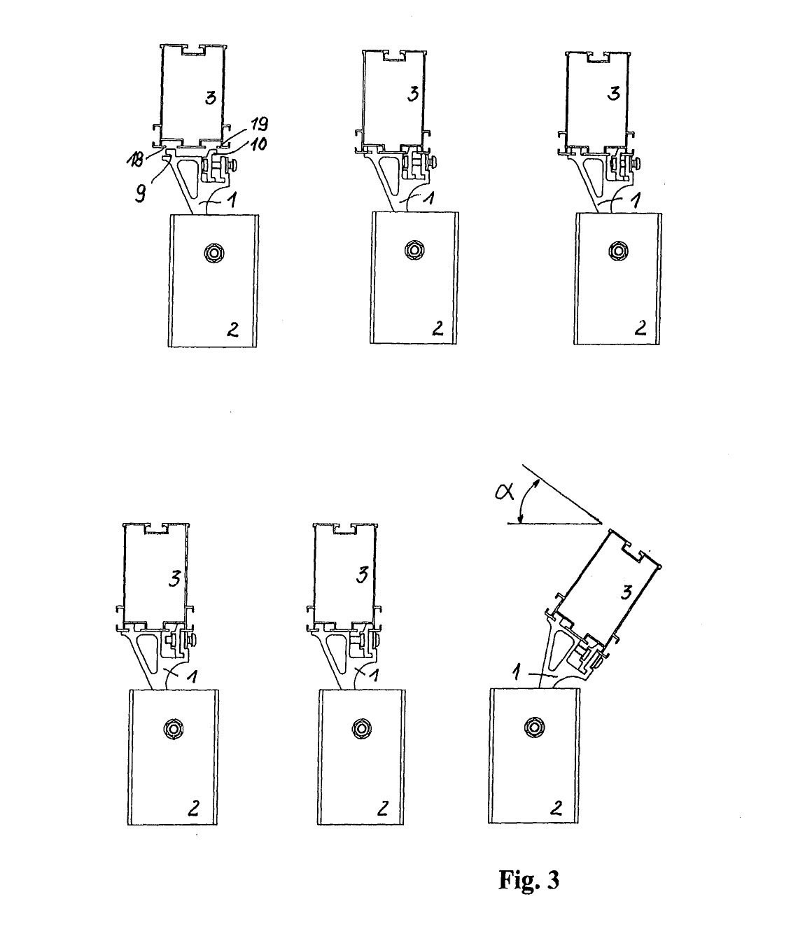

FIG. 3 shows the girder mounting.

FIG. 1 shows an overview of the parts of the outdoor frame system used in a preferred embodiment: pedestal bearing 1, support 2, girder 3, bolt connection 4, clamping jaw 10, clamping screw 12, locking plate 13 and clamping bolt nut 16.

The support 2 with a hollow profile is connected to the girder 3 by means of the pedestal bearing 1.

The connection between the support 2 and the pedestal bearing 1 is a bolt connection 4, in which the bolt 5 is guided through opposing support walls of the support 2 and thus passes through the pedestal bearing 1 through the foot-end eyelet 6 in the pedestal bearing 1 within the support 2. Two side faces of the pedestal bearing 1 lie flat against the inner profile surfaces of the support 2, or are only a small distance from said profile surfaces such that by tightening the bolt connection 4, the side faces can be braced with the profile surfaces, producing a friction closure.

The pedestal bearing 1 protrudes beyond the upper end of the support, and at the head end has a contact surface 8 for the girder 3 and has means 7 for producing a clamping connection to the attachments of the girder 3.

The form of the pedestal bearing foot, the hollow profile of the supports 2 and the arrangement of the bolt connection 4 are matched to one another in such a manner that the pedestal bearing 1 and therefore the contact surface 8 are able to tilt by an angle α about the axis of the bolt connection 4. The angle of inclination α which can be achieved with respect to the horizontal arrangement of the contact surface 8 should be up to 45°, preferably up to 35°, in order to achieve an optimum position of the solar panels with respect to the sun.

The attachments of the girder 3 for producing the clamping connection to the pedestal bearing 1 consist of bent webs 18, 19 on the contact surface side of the girder 3, whereby the free web ends face each other.

A support surface 17 of the girder 3 is arranged for the contact surface 8 of the pedestal bearing 1 between the bent webs 18, 19 and at a distance from said webs. The support surface 17 and the outer surfaces of the bent parts of the webs 18, 19 are located in one plane.

The means 7 of the pedestal bearing 1 for producing the clamping connection to the attachments of the girder 3 consist of a stationary jaw 9 and a movable clamping jaw 10, which can be brought into engagement with the attachments of the girder 3.

This is effected here in that the free end of the web 18 of the girder 3 engages in a groove of the jaw 9 and engages the clamping jaw 10 which is movably arranged at the head end on the pedestal bearing 1 over the other web 19.

The clamping jaw 10 is displaced in a guide groove 14 at the head end of the pedestal bearing 1 in such a manner that the clamping jaw 10 can be displaced from one groove wall towards the other groove wall. To that end, the outer groove wall 11 of the guide groove 14 comprises a bore for accommodating a clamping screw 12, said clamping screw 12 having a threaded connection with the clamping jaw 10, so that the clamping jaw 10 can be displaced by turning the clamping screw 12.

The clamping jaw 10 has a bore for the threaded connection between the clamping screw 12 and the clamping jaw 10, behind which bore a clamping bolt nut 16 is arranged in a rotationally fixed manner in an offset groove 15.

The clamping jaw cross section is a U-profile, whereby on fixing the girder 3 the one outer leg engages over the bent web 19 of the girder 3, while the other leg is supported in a groove 20 of the groove wall 11.

In addition, it is shown that an elastic locking plate 13, which is braced on clamping the girder 3, is arranged between the groove wall 11 and the head of the clamping screws 12.

FIG. 2 shows a side view of the pedestal bearing 1. It can be clearly seen that all of the formed parts provided for functional and material economy reasons extend in one direction. The functional formed parts include, in particular, the eyelet 6, the stationary jaw 9 with the groove for the web 18 and the guide groove 14 with the foot groove 20 for the leg of the clamping jaw 10.

Therefore the prerequisites are created for producing pedestal bearings 1 as extruded profiles and then producing the individual pedestal bearings 1 according to the desired width by cutting them to length.

Starting from the top left, FIG. 3 shows the various stages of mounting the girder 3 on the pedestal bearing 1. The girder 3 is placed on the pedestal bearing 1 such that the bent web 18 outside the jaw 9 and the web 19 outside the clamping jaw 10 rest on the pedestal bearing 1. Since the support surface 17 and the outer surfaces of the bent parts of the webs 18, 19 are located in one plane and the jaws 9 and 10 project beyond the contact surface 8 at the head end, the conditions exist, on displacement of the girder 3 in the direction of the fixed jaw 9, for the girder to slide into the groove of the jaw 9 and the clamping jaw 10 to engage the web 19 during clamping. These two steps are carried out simultaneously, namely when the clamping screw 12 is tightened.

Inclination angles α of 0° to 35° can be achieved with the pedestal bearing in the illustrated embodiment.

### LIST OF REFERENCE NUMERALS

1 Pedestal bearing

2 Support

3 Girder

4 Bolt connection between support and pedestal bearing

5 Bolt

6 Eyelet

7 Contact surface and attachments for the girder

8 Contact surface

9 Jaw

10 Clamping jaw

11 Groove wall

12 Clamping screw

13 Locking plate

14 Guide groove for a jaw

15 Groove for clamping bolt nut

16 Clamping bolt nut

17 Support surface

18 Bent web

19 Bent web

20 Groove

1. An outdoor frame system in which supports (2) with a hollow profile are connected to girders (3) by pedestal bearings (1), wherein the connection between the support (2) and the pedestal bearing (1) is a bolt connection (4), in which a bolt (5) is guided through opposing support walls and thus passes through the pedestal bearing (1) through a foot-end eyelet (6) in the pedestal bearing (1) within the support (2), wherein the pedestal bearing (1) protrudes beyond the upper end of the support, and at the head end has a contact surface (8) for the girder (3) and has means (7) for producing a clamping connection to attachments of the girder (3), and wherein the form of the pedestal bearing foot, the hollow profile of the supports (2) and the arrangement of the bolt connection (4) are matched to one another in such a manner that the pedestal bearing (1) and therefore the contact surface (8) are able to tilt by an angle α about the axis of the bolt connection (4).

2. The outdoor frame system according to claim 1, wherein the attachments of the girder (3) for producing a clamping connection to the pedestal bearing (1) consist of bent webs (18, 19) on the contact surface side of the girder (3), whereby the free web ends face each other.

3. The outdoor frame system according to claim 1, wherein the means (7) of the pedestal bearing (1) for producing a clamping connection to the attachments of the girder (3) consist of a stationary jaw (9) and a movable clamping jaw (10), both of which can be brought into engagement with the attachments of the girder (3).

4. The outdoor frame system according to claim 2, wherein the free end of the web (18) of the girder (3) engages in a groove of the jaw (9) and engages the clamping jaw (10) which is movably arranged at the head end on the pedestal bearing (1) over the other web (19).

5. The outdoor frame system according to claim 2, wherein a support surface (17) of the girder (3) is arranged for the contact surface (8) of the pedestal bearing (1) between the bent webs (18, 19) and at a distance from said webs.

6. The outdoor frame system according to any claim 2, wherein the support surface (17) and the outer surfaces of the bent parts of the webs (18, 19) are located in one plane.

7. The outdoor frame system according to claim 1, wherein the pedestal bearing (1) has a guide groove (14) at the head end for the movable clamping jaw (10) such that the clamping jaw (10) can be displaced from one groove wall towards the other groove wall.

8. The outdoor frame system according to claim 7, wherein the outer groove wall (11) of the guide groove (14) comprises a bore for accommodating a clamping screw (12), said clamping screw (12) having a threaded connection with the clamping jaw (10), so that the clamping jaw (10) can be displaced by turning the clamping screw (12).

9. The outdoor frame system according to claim 8, wherein the clamping jaw (10) has a bore for the threaded connection between the clamping screw (12) and the clamping jaw (10), behind which bore a clamping bolt nut (16) is arranged in a rotationally fixed manner in an offset groove (15).

10. The outdoor frame system according to claim 3, wherein the clamping jaw (10) has a U-profile in cross section, whereby on fixing the girder (3) the one outer leg engages over the bent web (19) of the girder (3), while the other leg is supported in a groove (20) of the groove wall (11).

11. The outdoor frame system according to claim 8, wherein an elastic locking plate (13), which is braced on clamping the girder (3), is arranged between the groove wall (11) and the head of the clamping screws (12).

12. The outdoor frame system according to claim 1, wherein the angle of inclination α which can be achieved with respect to a horizontal arrangement of the contact surface (8) is up to 45°, preferably up to 35°.

13. The outdoor frame system according to claim 1, wherein two side faces of the pedestal bearing (1) lie flat against the inner profile surfaces of the support (2), or are only a small distance from said profile surfaces such that by tightening the bolt connection (4), the side faces can be braced with the profile surfaces, producing a friction closure.

14. The outdoor frame system according to claim 1, wherein at least one of the components
pedestal bearings (1),
supports (2),
girders (3),
movable clamping jaw (10) and
locking plate (13)
consist of cut-to-length extruded profiles.
